(19) United States
(12) Patent Application Publication
(10) Pub. No.: US 2024/0222605 A1
(43) Pub. Date: Jul. 4, 2024

(54) NEGATIVE ELECTRODE ACTIVE MATERIAL FOR RECHARGEABLE LITHIUM BATTERY, METHOD OF PREPARING SAME, AND RECHARGEABLE LITHIUM BATTERY INCLUDING SAME

(71) Applicants: PUKYONG NATIONAL UNIVERSITY INDUSTRY-UNIVERSITY COOPERATION FOUNDATION, Busan (KR); Industry-Academic Cooperation Foundation, Chosun University, Gwangju (KR)

(72) Inventors: Pilgun Oh, Busan (KR); Yoonkook Son, Gwangju (KR)

(21) Appl. No.: 18/398,138

(22) Filed: Dec. 27, 2023

(30) Foreign Application Priority Data
Jan. 4, 2023 (KR) 10-2023-0001354

(51) Int. Cl. H01M 4/36; H01M 4/38; H01M 4/587; H01M 10/0525

(52) U.S. Cl. CPC H01M 4/366; H01M 4/38; H01M 4/386; H01M 4/587; H01M 10/0525; H01M 2004/027

(57) ABSTRACT

This disclosure provides a negative electrode active material for a rechargeable lithium battery, a method of preparing the same, and a rechargeable lithium battery including the same. The negative electrode active material for a rechargeable lithium battery includes crystalline carbon having a plurality of pores therein, and lithiophilic material inside the plurality of pores, wherein the lithiophilic material is not present on the outer surface of the crystalline carbon.

### CROSS-REFERENCE TO RELATED APPLICATION

This application claims priority to and the benefit of Korean Patent Application No. 10-2023-0001354 filed in the Korean Intellectual Property Office on Jan. 4, 2023, the entire contents of which are incorporated herein by reference.

### BACKGROUND OF THE INVENTION

### (a) Field of the Invention

This disclosure relates to a negative electrode active material for a rechargeable lithium battery, a method of preparing the same and a rechargeable lithium battery including the same.

### (b) Description of the Related Art

A portable information device such as a cell phone, a laptop, smart phone, and the like or an electric vehicle has used a rechargeable lithium battery having high energy density and excellent portability as a driving power source.

Such a rechargeable lithium battery may be divided into a lithium metal battery, a lithium ion battery, a lithium polymer battery. Among these, the lithium metal battery uses a lithium metal or a lithium alloy as a negative electrode active material and have the advantage of achieving the highest energy density, and thus ongoing research is being conducted.

However, the rechargeable lithium battery using the lithium metal electrode has a problem of forming no stable interface between the lithium metal electrode and an electrolyte and thus having a continuous decomposition reaction (side reaction) of the electrolyte due to high reactivity with lithium metal and surface unevenness during electrodeposition and exfoliation of the lithium metal on the electrode during the charging and discharging. This electrolyte side reaction may not only sharply increase battery resistance but also deplete the electrolyte and available lithium in the battery, deteriorating efficiency and a cycle-life of the battery. In addition, as the lithium metal battery is repeatedly charged and discharged, dendrite is formed on the negative electrode surface, causing battery safety issues. Accordingly, research on using lithium metal as a charge and discharge material is underway to solve the problems as well as to secure high energy density.

### SUMMARY OF THE INVENTION

In the present disclosure, a reaction of lithium metal is selectively induced inside a specific host to prevent lithium metal from directly contacting the electrolyte and to control the growth of dendrites.

An embodiment provides a negative electrode active material for a rechargeable lithium battery in which a lithiophilic material is coated inside the pores of crystalline carbon to induce reduction and oxidation of lithium metal inside the pores, thereby preventing side reactions between lithium metal and the electrolyte and controlling the growth of dendrites.

Another embodiment provides a method for preparing the negative electrode active material.

Another embodiment provides a rechargeable lithium battery having excellent energy density, efficiency, cycle-life characteristics, and safety by including the negative electrode active material.

A negative electrode active material for a rechargeable lithium battery according to an embodiment includes crystalline carbon having a plurality of pores therein, and a lithiophilic material inside the plurality of pores, wherein the lithiophilic material is not present on the outer surface of the crystalline carbon.

The lithiophilic material may be included in an amount of about 1 wt % to about 70 wt % based on a total amount of the negative electrode active material.

The lithiophilic material may include Pt, Al, Mg, Zn, Ag, Au, Si, Sn, Co, an alloy thereof, or a combination thereof.

The lithiophilic material may be a catalyst that induces lithium ions to be reduced and precipitated into lithium metal within the pores when charging the rechargeable lithium battery.

A method of preparing a negative electrode active material for a rechargeable lithium battery according to another embodiment includes depositing a precursor of a lithiophilic material on crystalline carbon having a plurality of pores thereinto coat the internal pores and outer surfaces of the crystalline carbon with the lithiophilic material, and etching the outer surface of the crystalline carbon coated with the lithiophilic material to remove the lithiophilic material on the outer surface of the crystalline carbon.

The method may further include, after coating the internal pores and outer surfaces of the crystalline carbon with the lithiophilic material, introducing a aqueous solvent into the crystalline carbon coated with the lithiophilic material and then performing a cooling.

The cooling process may be performed using a gaseous, liquid, or solid coolant.

The gaseous coolant may be selected from low-temperature air, nitrogen gas, oxygen gas, hydrogen gas, carbon monoxide, carbon dioxide, helium, argon, ammonia, methane, ethane, or a combination thereof.

The liquid coolant may be selected from liquid air, liquid nitrogen, liquid oxygen, liquid hydrogen, liquid carbon monoxide, liquid helium, liquid argon, liquid ammonia, liquid methane, liquid ethane, or a combination thereof.

The solid coolant may be selected from low-temperature metals, ceramics, dry ice, or a combination thereof.

The lithiophilic material on the outer surfaces of the crystalline carbon may be removed by wet etching or dry etching.

Steps of the wet etching may include placing crystalline carbon coated with a lithiophilic material on an upper part of a filter (S210), and pouring an etching solution on the crystalline carbon and passing it through (S220).

Another embodiment provides a rechargeable lithium battery comprising a positive electrode and a negative electrode facing each other, wherein the negative electrode includes the negative electrode active material described above.

The negative electrode active material may include lithium metal precipitated inside the pores of the negative electrode active material.

In the rechargeable lithium battery, a capacity ratio (N/P ratio) of the negative electrode to the positive electrode may be less than about 1.

The rechargeable lithium battery may be a composite rechargeable lithium battery of a lithium ion battery and a lithium metal battery.

Another embodiment provides a rechargeable lithium battery system including the rechargeable lithium battery and a driving voltage unit configured to apply a potential of the negative electrode at about 0 V or less.

In the negative electrode active material for a rechargeable lithium battery according to an embodiment, a lithiophilic material is coated on the pores of crystalline carbon to induce selective reduction and oxidation of lithium metal in the internal pores, and to prevent safety problems and changes in electrode volume due to dendritic lithium precipitation. Additionally, since lithium metal is precipitated in the internal pores of crystalline carbon, direct exposure of the lithium metal to the electrolyte can be prevented, thereby improving the safety of the rechargeable lithium battery.

In addition, the rechargeable lithium battery according to an embodiment is used as a composite rechargeable lithium battery of lithium ion battery and lithium metal battery, and compared to existing lithium-ion batteries, the rechargeable lithium battery according to an embodiment can have a higher specific capacity (>800 mAh/g) and can simultaneously secure high energy density (>1000 Wh/L) and stability, making it applicable to electric transportation.

### BRIEF DESCRIPTION OF THE DRAWINGS

FIG. 1 is a view schematically showing the structure of a negative electrode active material for a rechargeable lithium battery according to an embodiment.

FIGS. 2A and 2B are schematic views showing the behavior of lithium ions in the negative electrode active material for a rechargeable lithium battery during charging.

FIG. 3 is a flowchart showing a preparing process of a negative electrode active material for a rechargeable lithium battery according to an embodiment.

FIG. 4 is a flowchart showing a preparing process of a negative electrode active material for a rechargeable lithium battery according to another embodiment.

FIG. 5 schematically shows a specific example of an etching process during the preparing process of a negative electrode active material for a rechargeable lithium battery.

FIG. 6 is a schematic view showing a rechargeable lithium battery according to an embodiment.

FIG. 7A is a scanning electron microscope (SEM) photograph of a negative electrode active material according to Example 1 and FIG. 7B is a SEM photograph of a cross section of the negative electrode active material according to Example 1.

FIG. 8A is a scanning electron microscope (SEM) photograph of a negative electrode active material according to Comparative Example 2 and FIG. 8B is a SEM photograph of a cross section of the negative electrode active material according to Comparative Example 2.

FIG. 9A is a scanning electron microscope (SEM) photograph of a negative electrode active material according to Example 3, and FIG. 9B is a SEM photograph of a cross section of the negative electrode active material according to Example 3.

FIG. 10A is a scanning electron microscope (SEM) photograph of a negative electrode active material according to Comparative Example 3, and FIG. 10B is a SEM photograph of a cross section of the negative electrode active material according to Comparative Example 3.

FIGS. 11 and 12 are cross-sectional photographs of the negative electrode after charging and discharging of a half-cell including the negative electrode active material according to Example 2 and Comparative Example 2, respectively.

### DETAILED DESCRIPTION OF THE EMBODIMENTS

Hereinafter, embodiments of the present invention will be described in detail with reference to the accompanying drawings. Since the present invention can be subject to various changes and have various forms, specific embodiments will be illustrated in the drawings and described in detail in the present disclosure. However, this is not intended to limit the present invention to a specific disclosed form, and should be understood to include all changes, equivalents, and substitutes included in the spirit and technical scope of the present invention. While describing each drawing, similar reference numerals are used for similar components.

The terminology used herein is for the purpose of describing particular embodiments only and is not intended to be limiting of the invention. The singular forms may include plural forms unless the context clearly dictates otherwise. In this application, the terms “comprises,” “having”, etc. are intended to specify the presence of stated features, steps, acts, elements, parts, or combinations thereof. However, the terms may not exclude the presence or addition of one or more other features, steps, acts, elements, parts, or combinations thereof.

Unless defined otherwise, all terms used herein, including technical or scientific terms, have the same meaning as commonly understood by one of ordinary skill in the art to which this invention belongs. Terms such as those defined in commonly used dictionaries are to be interpreted as having meanings that are consistent with the meanings of the context in the relevant art, and are not to be construed in an idealized or overly formal sense unless expressly defined in the present application.

It will be understood that when an element such as a layer, film, region, or substrate is referred to as being “on” another element, it may be directly on the other element or intervening elements may also be present. In contrast, when an element is referred to as being “directly on” another element, there are no intervening elements present.

In addition, unless explicitly described to the contrary, the word “comprise”, and variations such as “comprises” or “comprising”, will be understood to imply the inclusion of stated elements but not the exclusion of any other elements.

In addition, in this specification, the phrase “on a plane” means viewing a target portion from the top, and the phrase “on a cross-section” means viewing a cross-section formed by vertically cutting a target portion from the side.

The singular expression includes the plural expression unless the context clearly dictates otherwise.

As used herein, “combination thereof” means a mixture, laminate, composite, copolymer, alloy, blend, reaction product, and the like of the constituents.

In addition, the “average particle diameter” may be measured by a method well known to those skilled in the art, for example, may be measured by a particle size analyzer, or may be measured by a transmission electron microscope or a scanning electron microscope. Alternatively, it is possible to obtain an average particle diameter value by measuring particle diameter values using a dynamic light scattering method, performing data analysis, counting the number of particles for each particle size range, and calculating from this. As used herein, when a definition is not otherwise provided, average particle diameter may mean a diameter (D50) of particles having a cumulative volume of 50 volume % in a particle size distribution.

Herein, “or” is not to be construed as an exclusive meaning, for example, “A or B” is construed to include A, B, A+B, and the like.

As used herein, “at least one of A, B, or C,” “one of A, B, C, or a combination thereof” and “one of A, B, C, and a combination thereof” refer to each constituent element, and a combination thereof (e.g., A; B; C; A and B; A and C; B and C; or A, B, and C).

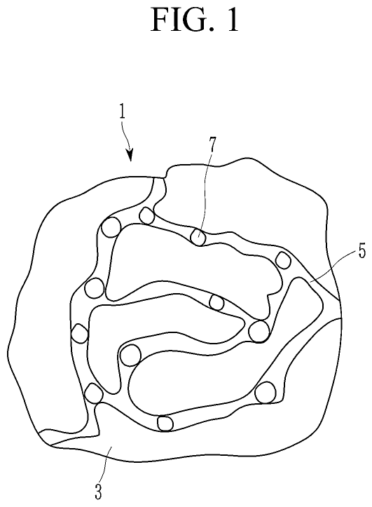

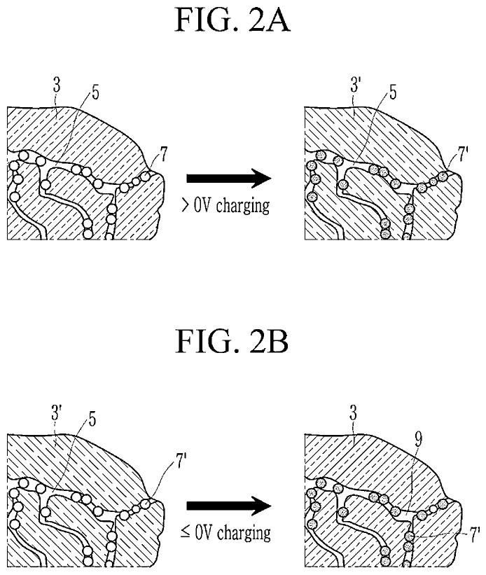

Hereinafter, a negative electrode active material for a rechargeable lithium battery according to an embodiment will be described with reference to FIGS. 1, 2A, and 2B.

FIG. 1 is a view schematically showing the structure of a negative electrode active material for a rechargeable lithium battery according to an embodiment and FIGS. 2A and 2B is a schematic view showing the behavior of lithium ions in the negative electrode active material for a rechargeable lithium battery during charging.

Referring to FIG. 1, the negative electrode active material 1 for a rechargeable lithium battery according to an embodiment includes crystalline carbon 3 having a plurality of pores 5 therein and a lithiophilic material 7 inside the plurality of pores 5. The negative electrode active material 1 for a rechargeable lithium battery exhibits a behavior of a lithium ion battery in which electricity is generated through a reversible intercalation and deintercalation reaction of lithium ions into crystalline carbon during charging/discharging, while also a behavior of a lithium metal battery by selectively inducing precipitation of lithium metal within the pores of crystalline carbon.

The crystalline carbon 3 can serve as a host that sufficiently transfers electrons and controls expansion during charging and discharging. The crystalline carbon 3 may be graphite having a plurality of internal pores, and natural graphite or artificial graphite may be used. An average particle diameter of the crystalline carbon 3 is not particularly limited, but may range from about 1 μm to about 20 μm. In an embodiment, the average particle diameter may be greater than or equal to about 5 μm, greater than or equal to about 7 μm, greater than or equal to about 10 μm, greater than or equal to about 12 μm, or greater than or equal to about 15 μm. When the average particle size of the crystalline carbon 3 is within the above range, the process of introducing a lithiophilic material into the crystalline carbon 3 can be easily performed.

In addition, the crystalline carbon 3 has a plurality of pores 5 formed therein, and may have a porosity of about 10% to about 50%, for example, greater than or equal to about 11%, or greater than or equal to about 12% and less than or equal to about 49%, less than or equal to about 48%, less than or equal to about 47%, less than or equal to about 46%, or less than or equal to about 45%. Within the above porosity range, the internal pores of the crystalline carbon 3 can be coated with a sufficient amount of a lithiophilic material.

The lithiophilic material 7 is a material that can induce lithium precipitation by inducing the reduction and oxidation of lithium metal, and exists only inside the pores 5 of the crystalline carbon 3, and is not present on the outer surface of the crystalline carbon 3. Herein, the lithiophilic material 7 is not present on the outer surface of the crystalline carbon 3, meaning that, for example, it is present on the outer surface of the crystalline carbon 3 in an amount of less than or equal to about 0.25 wt %, less than or equal to about 0.2 wt %, less than or equal to about 0.1 wt %, less than or equal to about 0.09 wt %, less than or equal to about 0.08 wt %, less than or equal to about 0.07 wt %, less than or equal to about 0.06 wt %, less than or equal to about 0.05 wt %, less than or equal to about 0.04 wt %, less than or equal to about 0.03 wt %, less than or equal to about 0.02 wt %, or less than or equal to about 0.01 wt % based on a total amount of the total negative electrode active material 1.

The lithiophilic material 7 may be present in an amount of about 1 wt % to about 70 wt % based on the total amount of negative electrode active material. Within the above range, the lithiophilic material may be present in an amount of greater than or equal to about about 1.5 wt %, greater than or equal to about 1.6 wt %, greater than or equal to about 1.7 wt %, greater than or equal to about 1.8 wt %, greater than or equal to about 1.9 wt %, greater than or equal to about 2 wt %, greater than or equal to about 2.5 wt %, greater than or equal to about 3 wt %, greater than or equal to about 3.5 wt %, greater than or equal to about 4 wt %, greater than or equal to about 4.5 wt %, greater than or equal to about 5 wt %, greater than or equal to about 6 wt %, or greater than or equal to about 7 wt % and less than or equal to about 69 wt %, less than or equal to about 68 wt %, less than or equal to about 67 wt %, less than or equal to about 66 wt %, or less than or equal to about 65 wt % based on the total amount of the negative electrode active material. Within the above range, the lithiophilic material 7 can sufficiently perform the role of a catalyst that induces precipitation of lithium metal within the pores 5.

The lithiophilic material 7 may be present in the form of nanoparticles attached to the inner surface of the pores 5 of the crystalline carbon 3 or as a film-shaped coating layer on the inner surface of the pores 5. At this time, the nanoparticles may be spherical particles or quasi-spherical particles with a diameter of about 5 to about 100 nm, and the film-shaped coating layer may have a thickness of about 5 to about 100 nm.

The lithiophilic material 7 may induce reduction and oxidation of lithium metal inside the pores 5 of the crystalline carbon 3, thereby preventing a change in the volume of the negative electrode active material 1. In addition, since the lithiophilic material 7 exists only inside the pores 5, direct exposure of the lithium metal precipitated inside the pores 5 to the electrolyte can be prevented, thereby suppressing unnecessary side reactions.

The lithiophilic material may include metals that can electrochemically induce reduction and oxidation of lithium metal. In an embodiment, the lithiophilic material may be a catalyst material that can induce the oxidation/reduction of lithium metal at a voltage exceeding about 0 V without interfering with the oxidation/reduction of lithium metal at a voltage of less than or equal to about 0 V. For example, the lithiophilic material may include Pt, Al, Mg, Zn, Ag, Au, Si, Sn, Co, an alloy thereof, or a combination thereof, but is not limited thereto.

As shown in FIG. 2A, the negative electrode active material 1 for a rechargeable lithium battery having the above structure, when charged at a voltage exceeding 0 V (charge voltage>0 V), lithium ions are intercalated into each layer of the crystalline carbon 3 and the crystalline carbon 3 is lithiated to produce lithiated crystalline carbon 3′, and the lithiophilic material is also doped with Li to produce a lithiated lithiophilic material 7′. For example, if the crystalline carbon 3 is graphite, lithiated graphite is generated when charged at a voltage exceeding about 0 V, and if the lithiophilic material is Si, lithiated Si is generated.

At this time, a rechargeable lithium battery containing the negative electrode active material may exhibit the behavior of a lithium ion battery that generates electricity through reversible intercalation and deintercalation reactions of lithium ions during charging/discharging.

Thereafter, as shown in FIG. 2B, when the charging voltage is set to 0 V or less (charging voltage≤0 V), the lithiated lithiophilic material 7′ present inside the pores 5 of the crystalline carbon 3, lithium ions may be selectively reduced inside the pores 5 and lithium metal 9 may be precipitated. That is, the lithiated lithiophilic material 7′ can act as a lithiophilic catalyst that induces lithium ions to be reduced and precipitated into lithium metal within the pores 5 when the charging voltage is set to 0 V or less. In FIG. 2B, the inside of the pores 5 is shown to be filled with lithium metal 9, but some pores 5 may remain unfilled.

At this time, the rechargeable lithium battery including the negative electrode active material may exhibit behavior of the lithium metal battery in which lithium ions are reduced within the pores 5 and precipitated into lithium metal during charging, and during discharging, the lithium metal is oxidized back to lithium ions to generate electricity. Since this reaction takes place inside the pores 5, the redox reaction of lithium metal can be stably induced. As a result, it is possible to secure high capacity and energy density, which are the advantages of a lithium metal battery, while preventing direct exposure of lithium metal to the electrolyte, thereby improving the safety of a rechargeable lithium battery by suppressing side reactions with the electrolyte.

As described above, the rechargeable lithium battery including the negative electrode active material may be a composite rechargeable lithium battery of a lithium ion battery and a lithium metal battery by adjusting the charging voltage. Therefore, the rechargeable lithium battery according to an embodiment can have a higher specific capacity ((>800 mAh/g) compared to existing lithium ion batteries, and can simultaneously secure high energy density (>1000 Wh/L) and safety. Additional configurations of the rechargeable lithium battery will be described later.

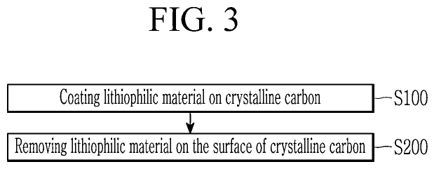

Hereinafter, a method of preparing the negative electrode active material for a rechargeable lithium battery will be described with reference to FIGS. 3 to 5.

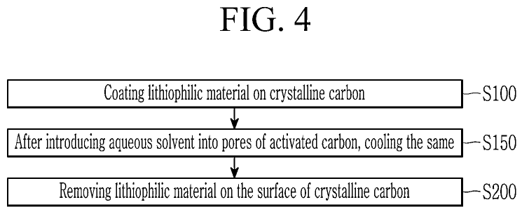

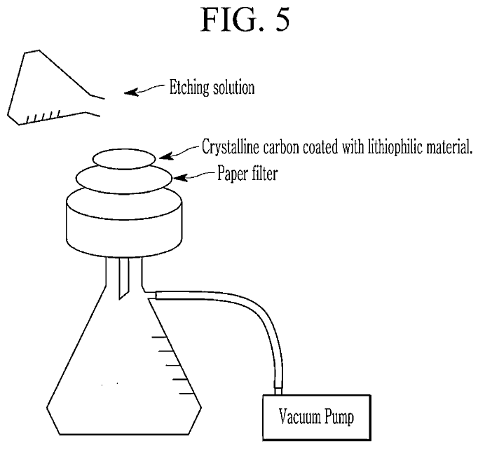

FIG. 3 is a flowchart showing a preparing process of a negative electrode active material for a rechargeable lithium battery according to an embodiment, FIG. 4 is a flowchart showing a preparing process of a negative electrode active material for a rechargeable lithium battery according to another embodiment, and FIG. 5 schematically shows a specific example of an etching process during the preparing process of a negative electrode active material for a rechargeable lithium battery.

Referring to FIG. 3, the method of preparing a negative electrode active material for a rechargeable lithium battery includes depositing a precursor of a lithiophilic material on crystalline carbon having a plurality of pores thereinto coat the internal pores and outer surfaces of the crystalline carbon with the lithiophilic material (S100), and etching the outer surface of the crystalline carbon coated with the lithiophilic material to remove the lithiophilic material on the outer surface of the crystalline carbon(S200).

First, the lithiophilic material is coated on crystalline carbon having a plurality of pores, to the lithiophilic material is coated on the internal pores and outer surface of the crystalline carbon (S100).

The crystalline carbon and lithiophilic material are as described in the negative electrode active material.

The lithiophilic material may be coated by depositing a precursor of the lithiophilic material. The precursor of the lithiophilic material may be a compound containing a lithiophilic material. The compound containing the lithiophilic material may be selected depending on the lithiophilic material, and may be an organic material containing a lithiophilic material, an inorganic material containing a lithiophilic material, or a combination thereof. For example, the compound containing the lithiophilic material may be a hydride containing the lithiophilic material, halide containing the lithiophilic material, oxide containing the lithiophilic material, alkyl group-containing (alkylated) hydride containing the lithiophilic material, aryl group-containing hydride containing the lithiophilic material, containing the lithiophilic material alkoxide, containing the lithiophilic material organic salt, containing the lithiophilic material inorganic salt or a combination thereof. The alkyl group-containing hydride may include a C1 to C20 alkyl group, the aryl group-containing hydride may include a C6 to C20 aryl group, and the alkoxide may include a C1 to C20 alkoxy group. For example, when the lithiophilic material includes Si, the precursors of the lithiophilic material may include at least one selected from silane (SiH₄), disilane (Si₂H₆), Si₃H₈, silicon tetrachloride (SiCl₄), silicon tetrafluoride (SiF₄), SiHCl₃, Si₂Cl₆, SiH₃Cl, dichlorosilane (SiH₂Cl₂), trichlorosilane (SiHCl₃), SiOₓ (0<x≤2), methyl silane (CH₃SiH₃), phenylsilane, (CH₃)₂Cl₂Si, SiH₂(C₆H₅)₂, and (C₂H₅O)₄Si. For example, when the lithiophilic material includes Zn, precursors of the lithiophilic material may include at least one selected from an alkylated Zn compound, Zn alkoxide, C₂ to C₁₀ Zn carboxylate, Zn nitrate, Zn perchlorate, Zn sulfate, Zn acetylacetonate, Zn halide, Zn cyanide, Zn hydroxide, Zn oxide, and Zn peroxide.

The deposition process of the precursor of the lithiophilic material may be chemical vapor deposition or physical vapor deposition, for example thermal chemical vapor deposition, plasma-enhanced chemical vapor deposition, or microwave plasma-assisted chemical vapor deposition.

The deposition process may be performed in an atmosphere such as hydrogen (H₂), argon (Ar), or nitrogen (N₂).

Equipment for carrying out the deposition process may be a rotary furnace, a tube furnace, or a fluidized bed, and is not particularly limited.

Additionally, the deposition process may be selected in consideration of the melting point (Tₘ) of the precursor of the lithiophilic material and may be performed at a temperature of about 400 to about 1150° C., for example greater than or equal to about 450° C. or greater than or equal to about 500° C. and less than or equal to about 1150° C. or less than or equal to about 1000° C. The deposition process may be performed for about 0.1 to about 10 hours and may be adjusted depending on the deposition temperature. When the deposition process is carried out in the above temperature range, coating can be done by uniformly applying a large amount of a high-purity lithiophilic material.

As shown in FIG. 4, the preparing method may further include introducing an aqueous solvent into the crystalline carbon coated with the lithiophilic material and performing a cooling (S150) after the step (S100) of coating the lithiophilic material on the internal pores and outer surface of the crystalline carbon.

The cooling process can protect the lithiophilic material deposited in the pores of crystalline carbon in the etching process described later.

The process of introducing the aqueous solvent may include immersing the crystalline carbon coated with the lithiophilic material in the aqueous solvent or spraying the aqueous solvent on the crystalline carbon coated with the lithiophilic material. The aqueous solvent may include water, alcohol, or a combination thereof, and the alcohol may be a C₁ to C₁₀ alcohol such as methanol or ethanol, or polyhydric alcohols (diols or triols) such as ethylene glycol, diethylene glycol, triethylene glycol, propylene glycol, dipropylene glycol, 1,3-propanediol, glycerin, etc. The temperature of the aqueous solvent may be, for example, in the range of about 30° C. to about 80° C., about 30° C. to about 75° C., or about 30° C. to about 60° C.

Examples of cooling methods in the cooling process include cooling the crystalline carbon coated with the lithiophilic material by storing it in a cooling device such as a refrigerator or freezer, or contacting the crystalline carbon coated with the lithiophilic material with a coolant.

The cooling process can reduce the removal of lithiophilic materials present inside the pores in the etching process described later. In other words, by minimizing the contact of the etchant inside the pores with the lithiophilic material through the cooling process, it is possible to allow a greater amount of lithiophilic material to be present inside the pores.

The cooling process may be performed using a gaseous, liquid, or solid coolant.

Examples of the gaseous coolant may include low-temperature gases such as low-temperature air, nitrogen gas, oxygen gas, hydrogen gas, carbon monoxide, carbon dioxide, helium, argon, ammonia, methane, ethane or a combination thereof. The cooling method using the gaseous coolant may include storing crystalline carbon coated with a lithiophilic material in the presence of a gaseous coolant, spraying a gaseous coolant on crystalline carbon coated with a lithiophilic material, etc.

Examples of the liquid coolant may include low-temperature liquids such as liquid air, liquid nitrogen, liquid oxygen, liquid hydrogen, liquid carbon monoxide, liquid helium, liquid argon, liquid ammonia, liquid methane, liquid ethane or a combination thereof. The cooling method using a liquid coolant may include a method of immersing crystalline carbon coated with a lithiophilic material in a liquid coolant, and a method of spraying a liquid coolant onto crystalline carbon coated with a lithiophilic material.

Examples of the solid coolant may include low-temperature bulk items such as low-temperature metals, ceramics, dry ice or a combination thereof. The cooling methods using solid coolants may include covering part or all of the surface of crystalline carbon coated with lithiophilic materials with low-temperature bulk items and storing the same; covering part or all of the surface of crystalline carbon coated with a lithiophilic material, with a granular or powdered coolant and storing the same; or spraying granular or powder-type coolant onto crystalline carbon coated with a lithiophilic material.

Next, the lithiophilic material present on the surface of the crystalline carbon coated with the lithiophilic material is selectively removed (S200).

The removing of the lithiophilic material may be performed by wet etching or dry etching.

The wet etching can be performed by selectively removing only lithiophilic material present on the surface of crystalline carbon using an etching solution. As a result, the lithiophilic material selectively exists only in the pores of the crystalline carbon.

Specifically, the wet etching may include placing crystalline carbon coated with a lithiophilic material on the upper part of the filter as shown in FIG. 5 (S210), and pouring the etching solution onto the crystalline carbon and passing it through (S220). The filter may be a paper filter, but is not limited thereto.

The etching solution usable for the wet etching may be selected depending on the type of lithiophilic material. For example, if the lithiophilic material is Si, a basic solution selected from KOH, NaOH, or a combination thereof can be used; if the lithiophilic material is Ni, an acid solution selected from HNO₃, HCl, or a combination thereof, or a basic solution selected from KOH, NaOH, or a combination thereof can be used, and the basic solution may include K₃Fe(CN)₆; if the lithiophilic material is Zn, a mixed solution of copper sulfate, sodium chloride, and hydrochloric acid, etc. can be used; if the lithiophilic material is Ag, nitric acid, iron nitrate, etc. can be used; if the lithiophilic material is Au, a mixed solvent of methanol and nitric acid can be used, ammonium persulfate, etc. may be used; and if the lithiophilic material is Al, Keller's reagent, HCl, sodium hydroxide, etc. may be used, but are not limited thereto.

The concentration and usage amount of the etching solution can be easily selected depending on the lithiophilic material. For example, if the lithiophilic material is Zn, 20 to 40 g of a 1 to 10 M NaOH aqueous solution can be used, and if the lithiophilic material is Ag, 20 to 40 g of a 1 to 12 M nitric acid aqueous solution can be used.

Additionally, if the lithiophilic material is Sn, it can be removed by dry etching using a plasma process.

Meanwhile, after the step of removing the lithiophilic material (S200), a step of drying the obtained material at a temperature of greater than or equal to about 80° C. and less than or equal to about 90° C. for about 1 to about 3 hours is additionally performed to ensure that the lithiophilic material may be allowed to exist more stably inside the pores of crystalline carbon.

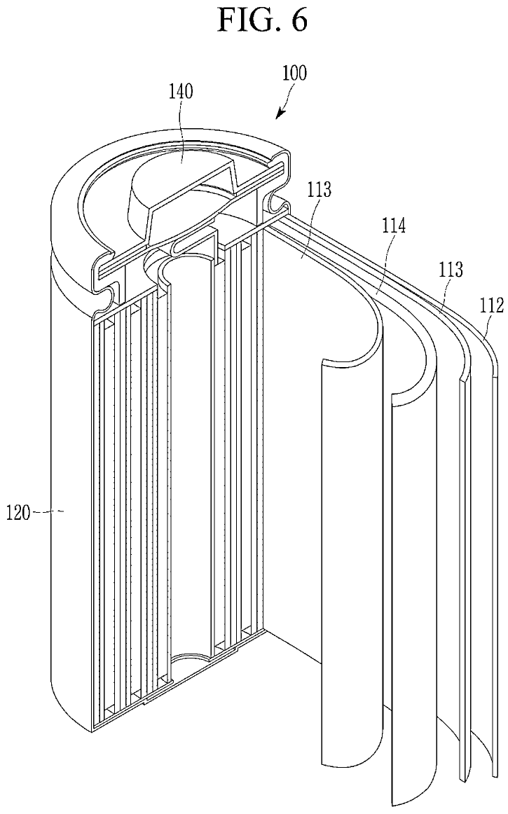

Hereinafter, a rechargeable lithium battery including the negative electrode active material will be described with reference to FIG. 6.

FIG. 6 is a schematic view showing a rechargeable lithium battery according to an embodiment. Referring to FIG. 6, the rechargeable lithium battery 100 according to an embodiment includes a battery cell including a positive electrode 114, a negative electrode 112 facing the positive electrode 114, a separator 113 between the positive electrode 114 and the negative electrode 112, and an electrolyte impregnating the positive electrode 114, negative electrode 112, and separator 113, a battery case 120 containing the battery cell, and a sealing member 140 sealing the battery case 120.

As described above, the rechargeable lithium battery containing the negative electrode active material may be a composite rechargeable lithium battery of a lithium ion battery and a lithium metal battery. The composite rechargeable lithium battery may include a positive electrode and a negative electrode facing each other and a separator between them. The positive electrode may include lithium transition metal oxide, etc., and the negative electrode may include the negative electrode active material described above.

The positive electrode of the composite rechargeable lithium battery may include a current collector and a positive electrode active material layer formed on the current collector. The positive active material may include lithiated intercalation compounds that reversibly intercalate and deintercalate lithium ions. Specifically, lithium transition metal oxide may be used, for example, one or more types of composite oxides of lithium and a metal selected from Co, Mn, Ni, and a combination thereof may be used, but is not limited thereto.

The negative electrode of the composite rechargeable lithium battery may include a current collector and a negative electrode active material layer formed on the current collector. The negative electrode active material layer includes the negative electrode active material described above.

In the composite rechargeable lithium battery, the N/P ratio (a capacity ratio) can be controlled to less than about 1, for example, less than or equal to about 0.9, less than or equal to about 0.8, less than or equal to about 0.7, less than or equal to about 0.6, or less than or equal to about 0.5. Herein, the N/P ratio means a total capacity of the negative electrode calculated by taking into account an area of the negative electrode and the capacity per g (gram) divided by a total capacity of the positive electrode calculated by taking into account an area of the positive electrode and the capacity per g (gram). In the composite rechargeable lithium battery, the N/P ratio can be adjusted to a desirable range that can induce lithium precipitation in consideration of capacity.

The N/P ratio has a significant impact on the safety and capacity of the battery, and in the case of conventional lithium ion batteries, it is manufactured to have a value of about 1 or more, but in the case of the composite rechargeable lithium battery of the present invention, the N/P ratio is adjusted to less than about 1, thereby exhibiting composite (combined) behaviors of a lithium ion battery and a lithium metal battery. That is, after lithium ions are intercalated into crystalline carbon, if the potential of the negative electrode is applied to about 0 V or less, the lithium ions inside the pores may precipitate as lithium metal. On the other hand, when the N/P ratio is about 1 or more, all lithium ions from the positive electrode are intercalated into the crystalline carbon, and thus precipitation of lithium metal cannot be induced.

The battery system including the composite rechargeable lithium battery may include a driving voltage unit configured to apply a potential of the negative electrode at about 0 V or less. Thereby, precipitation of lithium metal inside the crystalline carbon can be induced.

A composite rechargeable lithium battery including the configuration described above may exhibit a behavior of a lithium ion battery that generates electricity through reversible intercalation and deintercalation reactions of lithium ions into crystalline carbon during charge/discharge, and a behavior of a lithium metal battery by selectively inducing precipitation of lithium metal within the pores of crystalline carbon.

Therefore, the composite rechargeable lithium battery including the configuration described above can have a high specific capacity (>800 mAh/g) compared to existing lithium-ion batteries, and can simultaneously secure high energy density (>1000 Wh/L) and stability, and thus the composite rechargeable lithium battery including the configuration described above can be applied to means of mobile using electricity, such as IT (Information Technology) mobile devices, electric vehicles, and hybrid vehicles.

The separator 113 separates a positive electrode 114 and a negative electrode 112 and provides a transporting passage for lithium ions and may be any generally-used separator in a lithium ion battery. In other words, it may have low resistance to ion transport and excellent impregnation for an electrolyte. The separator 113 may include, for example, glass fiber, polyester, Teflon, polyethylene, polypropylene, polytetrafluoroethylene, or combinations thereof, and may be in non-woven or woven form. For example, in lithium ion batteries, a polyolefin-based polymer separator such as polyethylene and polypropylene are mainly used, and coated separators containing ceramic components or polymer materials may be used to ensure heat resistance or mechanical strength, and can optionally be single-layer or multi-layer.

The electrolyte may include a non-aqueous organic solvent, lithium salt, and optionally additives. The non-aqueous organic solvent serves as a medium for transmitting ions taking part in the electrochemical reaction of a battery. The non-aqueous organic solvent may be carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (EMC), ethylene carbonate (EC), propylene carbonate (PC), and butylene carbonate (BC), etc. The ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, etc., and the ketone-based solvent may include cyclohexanone. In addition, the alcohol-based solvent may be ethyl alcohol, isopropyl alcohol, etc., and the aprotic solvent may be R-CN (where R is a C2 to C20 linear, branched, or cyclic hydrocarbon group, and may contain a double bond, an aromatic ring, or an ether bond), amides such as dimethylformamide, dioxolanes such as 1,3-dioxolane, and sulfolanes.

Examples of the lithium salt include at least one supporting salt selected from LiPF₆, LiBF₄, LiSbF₆, LiAsF₆, LIN(SO₂C₂F₅)₂, Li(CF₃SO₂)₂N, LIN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LIN(CₓF₂ₓ₊₁SO₂)(C_{y}F_{2y+1}SO₂) (wherein x and y are natural numbers, for example, an integer ranging from 1 to 20), lithium difluoro(bisoxalato) phosphate, LiCl, Lil, LiB(C₂O₄)₂ (lithium bis(oxalato) borate, LiBOB), and lithium difluoro(oxalato)borate (LiDFOB).

The additives may include, for example, vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propenesultone (PST), propanesultone (PS), lithium tetrafluoroborate (LiBF₄), lithium difluorophosphate (LiPO₂F₂) and 2-fluoro biphenyl (2-FBP), or a combination thereof.

Hereinafter, various examples and experimental examples of the present invention will be described in detail. However, the following examples are only some examples of the present invention, and the present invention should not be construed as being limited to the following examples.

### Example 1

SiCl₄ (silicon tetrachloride) as an Si precursor was chemical vapor-deposited on graphite (an average particle diameter: 17 μm), so that 2 wt % of Si was coated on the internal pores and the surface of the graphite.

Subsequently, after positioning the graphite (1.5 g) coated with Si on top of a paper filter, a KOH solution (10 mol, 40 g) as an etching solution was poured and passed through it to remove Si present on the graphite surface.

Then, the reaction product was dried at a temperature of 85° C. for 2 hours to prepare a negative electrode active material for a rechargeable lithium battery in which Si was coated inside the pores of graphite.

### Example 2

SiCl₄ (silicon tetrachloride) as an Si precursor was chemical vapor-deposited on graphite (an average particle diameter: 17 μm), so that 6 wt % of Si was coated on the internal pores and the surface of the graphite.

Subsequently, after positioning the graphite (1.5 g) coated with Si on top of a paper filter, a KOH solution (10 mol, 40 g) as an etching solution was poured and passed through it to remove Si present on the graphite surface. This process was three times repeated.

Then, the reaction product was dried at a temperature of 85° C. for 2 hours to prepare a negative electrode active material for a rechargeable lithium battery in which Si was coated inside the pores of graphite.

### Example 3

Silver nitrate (AgNO₃) as an Ag precursor was chemical vapor-deposited on graphite (an average particle diameter: 17 μm), so that 70 wt % of Ag was coated on the internal pores and the surface of the graphite.

Subsequently, after positioning the graphite (1.5 g) coated with Ag on top of a paper filter, 20 g of a 6 M HNO₃ aqueous solution as an etching solution was poured and passed through it to remove Ag present on the graphite surface.

Then, the reaction product was dried at a temperature of 85° C. for 2 hours to prepare a negative electrode active material for a rechargeable lithium battery in which Ag was coated inside the pores of graphite.

### Example 4

Diethyl zinc as a Zn precursor was chemical vapor-deposited on graphite (an average particle diameter: 17 μm), so that 1 wt % of Zn was coated on the internal pores and the surface of the graphite.

Subsequently, after positioning the graphite (1.5 g) coated with Zn on top of a paper filter, 80 g of a 1 M NaOH aqueous solution as an etching solution was poured and passed through it to remove Zn present on the graphite surface.

Then, the reaction product was dried at a temperature of 85° C. for 2 hours to prepare a negative electrode active material for a rechargeable lithium battery in which Zn was coated inside the pores of graphite.

### Example 5

SiCl₄ (silicon tetrachloride) as an Si precursor was chemical vapor-deposited on graphite (an average particle diameter: 17 μm), so that 2 wt % of Si was coated on the internal pores and the surface of the graphite. The graphite was immersed in water at 60° C. and then, stirred to fill the water in the pores of the graphite. A resulting material obtained therefrom was added to liquid nitrogen so that ice was filled in the pores of the graphite.

Subsequently, after positioning the Si-coated graphite (1.5 g) on top of a paper filter, a KOH solution (10 mol, 40 g) as an etching solution was poured and passed through it to remove Si present on the graphite surface.

Then, the reaction product was dried at a temperature of 85° C. for 2 hours to prepare a negative electrode active material for a rechargeable lithium battery in which Si was coated inside the pores of graphite.

### Example 6

SiCl₄ (silicon tetrachloride) as an Si precursor was chemical vapor-deposited on graphite (an average particle diameter: 17 μm), so that 6 wt % of Si was coated on the internal pores and the surface of the graphite. The graphite was immersed in water at 60° C. and then, stirred to fill the water in the pores of the graphite. A resulting material obtained therefrom was added to liquid nitrogen so that ice was filled in the pores of the graphite.

Subsequently, after positioning the Si-coated graphite (1.5 g) on top of a paper filter, a KOH solution (10 mol, 40 g) as an etching solution was poured and passed through it to remove Si present on the graphite surface. This process was three times repeated.

Then, the reaction product was dried at a temperature of 85° C. for 2 hours to prepare a negative electrode active material for a rechargeable lithium battery in which Si was coated inside the pores of graphite.

### Example 7

Silver nitrate (AgNO₃) as an Ag precursor was chemical vapor-deposited on graphite (an average particle diameter: 17 μm), so that 70 wt % of Ag was coated on the internal pores and the surface of the graphite. The graphite was immersed in water at 60° C. and then, stirred to fill the water in the pores of the graphite. A resulting material obtained therefrom was added to liquid nitrogen so that ice was filled in the pores of the graphite.

Subsequently, after positioning the Ag-coated graphite (1.5 g) on top of a paper filter, 20 g of a 6 M HNO₃ aqueous solution as an etching solution was poured and passed through it to remove Ag present on the graphite surface.

Then, the reaction product was dried at a temperature of 85° C. for 2 hours to prepare a negative electrode active material for a rechargeable lithium battery in which Ag was coated inside the pores of graphite.

### Example 8

Diethyl zinc as a Zn precursor was chemical vapor-deposited on graphite (an average particle diameter: 17 μm), so that 1 wt % of Zn was coated on the internal pores and the surface of the graphite. The graphite was immersed in water at 60° C. and then, stirred to fill the water in the pores of the graphite. A resulting material obtained therefrom was added to liquid nitrogen so that ice was filled in the pores of the graphite.

Subsequently, after positioning the Zn-coated graphite (1.5 g) on top of a paper filter, 80 g of an 1 M NaOH aqueous solution as an etching solution was poured and passed through it to remove Zn present on the graphite surface.

Then, the reaction product was dried at a temperature of 85° C. for 2 hours to prepare a negative electrode active material for a rechargeable lithium battery in which Zn was coated inside the pores of graphite.

### Comparative Example 1

Graphite (Natural Flake Graphite SG-17, BTR New Material Group Co., Ltd.) was used as a negative electrode active material.

### Comparative Example 2

SiCl₄ (silicon tetrachloride) as an Si precursor was chemical vapor-deposited on graphite (an average particle diameter: 17 μm), so that 1 wt % of Si was coated on the internal pores and the surface of the graphite to prepare a negative electrode active material for a rechargeable lithium battery in which Si was all coated on the surface and the internal pores of the graphite.

### Comparative Example 3

Silver nitrate (AgNO₃) as an Ag precursor was chemical vapor-deposited on graphite (an average particle diameter: 17 μm), so that 70 wt % of Ag was coated on the internal pores and the surface of the graphite.

### Evaluation Example 1: Presence and Content of Lithiophilic Material

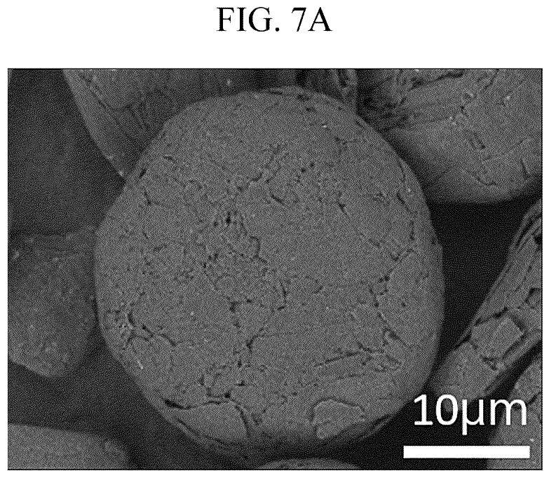

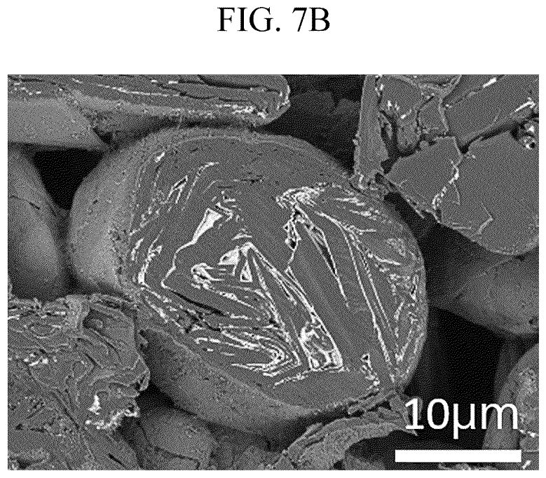

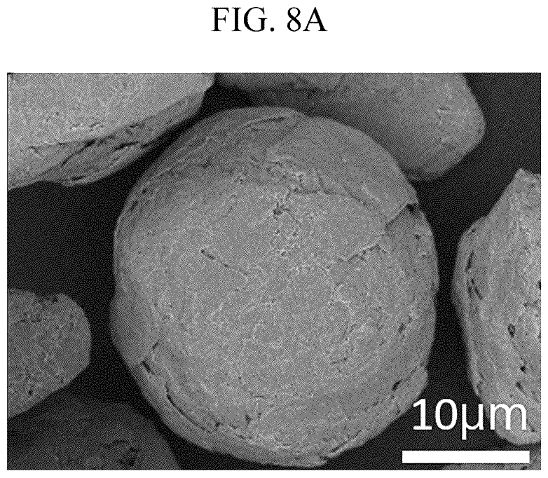

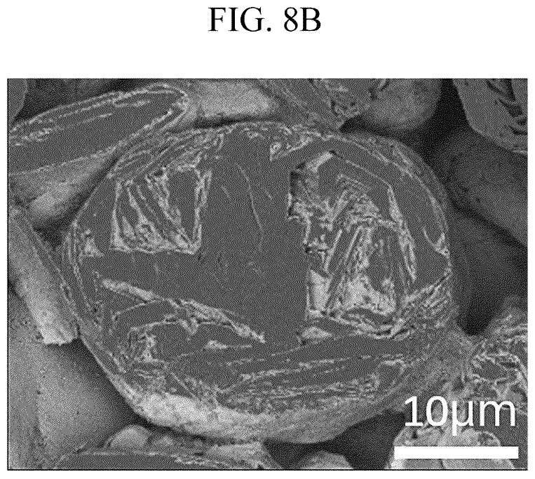

FIG. 7A shows a scanning electron microscope (SEM) photograph of the negative electrode active material of Example 1, while FIG. 7B shows an SEM photograph of the cross-section thereof, and FIG. 8A shows a scanning electron microscope (SEM) photograph of the negative electrode active material of Comparative Example 2, while FIG. 8B shows an SEM photograph of the cross-section thereof. Referring to FIGS. 7A to 8B, silicon was found not on the external surface but silicon was found inside the internal pores, in the negative electrode active material according to Example 1, but the negative electrode active material of Comparative Example 2 exhibited that silicon was all present both on the external surface and the internal pores.

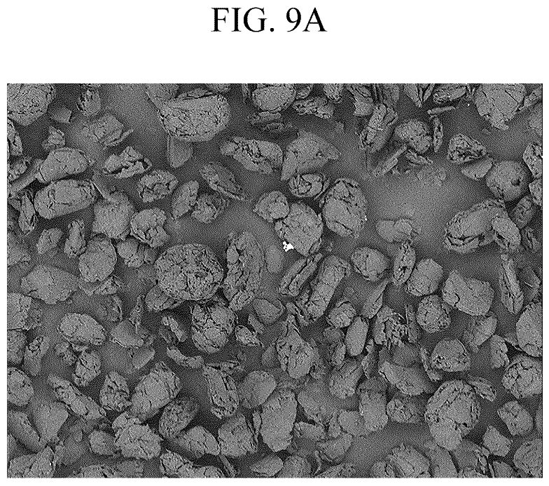

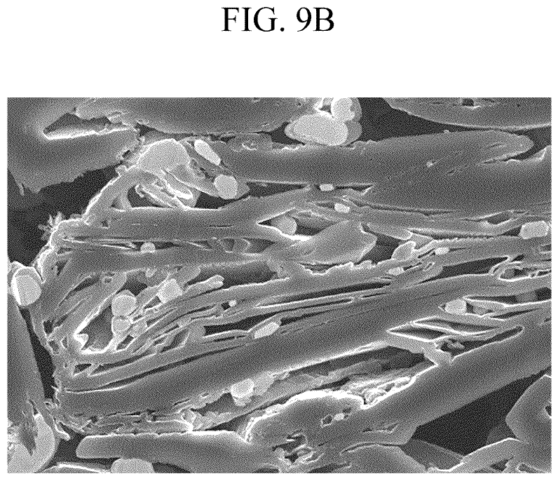

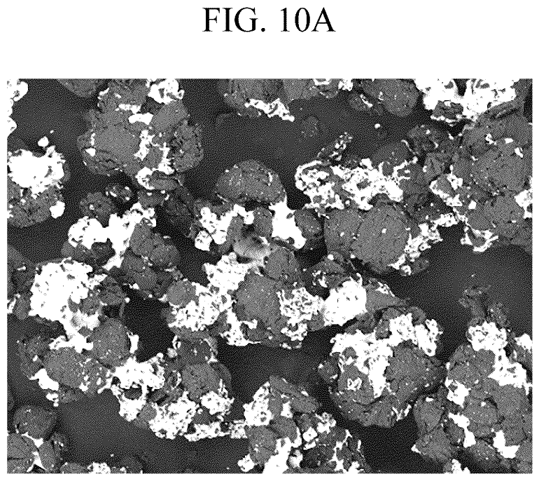

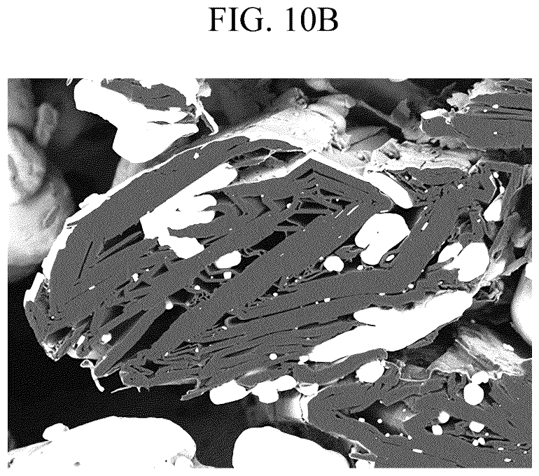

FIG. 9A shows a scanning electron microscope (SEM) photograph of the negative electrode active material of Example 3, while FIG. 9B shows an SEM photograph of the cross-section thereof, and FIG. 10A shows a scanning electron microscope (SEM) photograph of the negative electrode active material of Comparative Example 3, while FIG. 10B shows an SEM photograph of the cross-section thereof. Referring to FIGS. 9A to 10B, in the negative electrode active material of Example 3, Ag was not found on the surface but inside the pores, but the negative electrode active material of Comparative Example 3 exhibited that Ag was all present on both the external surface and the internal pores.

The negative electrode active materials according to Examples 1 and 2 and Comparative Examples 1 and 2 were measured with respect to each content of a lithiophilic material on the surface and the inside by using SEM-EDS (Energy Dispersive X-ray Spectometer), and the results are shown in Table 1.

The negative electrode active materials of Example 3 and Comparative Example 3 were measured with respect to each lithiophilic material content on the surface and the inside by using SEM-EDS (Energy Dispersive X-ray Spectometer), and the results are shown in Table 2.

Herein, the surface indicates the external surface of graphite, and the inside indicates a depth of less than or equal to 1 μm from the surface of graphite.

TABLE 1

| | | Carbon (wt %) | Silicon (wt %) |
|---|---|---|---|
| Example 1 | surface | 97.60 | 0.04 |
| | inside | 96.22 | 1.92 |
| Example 2 | surface | 98.64 | 0.22 |
| | inside | 95.29 | 4.01 |
| Comparative | surface | 97.44 | 0.03 |
| Example 1 | inside | 97.30 | 0.02 |
| Comparative | surface | 81.56 | 17.37 |
| Example 2 | inside | 97.58 | 8.97 |

TABLE 2

| | | Carbon (wt %) | Ag (wt %) |
|---|---|---|---|
| Example 3 | surface | 98.53 | 0.08 |
| | inside | 94.14 | 4.82 |
| Comparative | surface | 97.44 | 0.03 |
| Example 1 | inside | 97.30 | 0.02 |
| Comparative | surface | 69.15 | 27.65 |
| Example 3 | inside | 55.69 | 42.49 |

In Tables 1 and 2, wt % is obtained from areas of a carbon peak and a silicon peak in the EDS analysis.

Referring to Table 1, the negative electrode active materials of Examples 1 and 2 exhibited an Si content of less than or equal to 0.22 wt % on the graphite surface due to the etching process, which confirms that almost no Si was present on the graphite surface. This result is considered to indicate that Si was detected in a similar range to that of Comparative Example 1. Comparatively, the negative electrode active material of Comparative Example 2 exhibited an Si content of 17.37 wt % on the graphite surface.

On the other hand, the negative electrode active materials of Examples 1 and 2 and Comparative Example 2 exhibited that Si was present in internal pores of graphite.

Referring to Table 2, the negative electrode active material of Example 3 exhibited an Ag content of 0.08 wt % on the graphite surface due to the etching process, which confirmed that almost no Ag was present on the graphite surface. This result is considered to indicate that Ag was detected in a similar range to that of Comparative Example 1. Comparatively, the negative electrode active material of Comparative Example 3 exhibited that 27.65 wt % of Ag was present on the graphite surface.

On the other hand, the negative electrode active materials of Example 3 and Comparative Example 3 all exhibited that Ag was present in internal pores of graphite.

### Manufacture of Battery Cells

96 wt % of each of the negative electrode active materials of Examples 1 to 8 and Comparative Examples 1 to 3, 1 wt % of Super P (Timcal Graphite Carbon) as a conductive agent, 1.5 wt % of a styrene-butadiene rubber (SBR) as a binder, and 1.5 wt % of carboxylmethyl cellulose (CMC) were mixed in water to prepare negative electrode active material slurry, and the negative electrode active material slurry was coated on a Cu foil and then, pressed to manufacture each negative electrode. Herein, a loading level was 2.5 mg/cm².

Each of the manufactured negative electrodes and lithium metal as a counter electrode were used to assemble a 2030R coin-type half-cell in a glove box filled with argon. An electrolyte was prepared by using a mixed solvent of ethylene carbonate/ethylmethylcarbonate/diethylcarbonate (EC/EMC/DEC=3/5/2 in a volume ratio) and 1.3 M LiPF₆ and 0.2 wt % of LiBF₄ as a lithium salt.

### Evaluation Example 2: Checking Cross Section of Electrode During Charging and Discharging

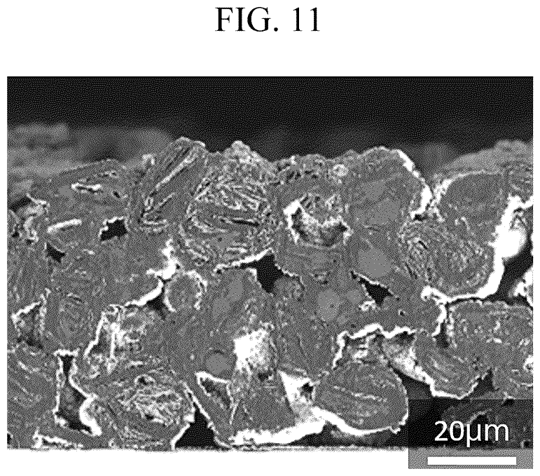

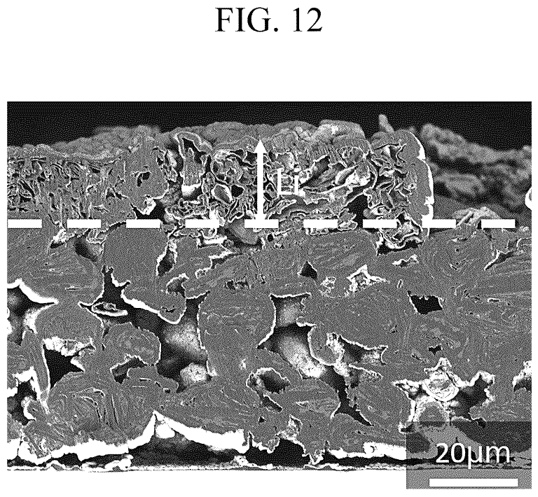

Each half-cell including each of the negative electrode active materials of Example 2 and Comparative Example 2 was charged (induce a lithiation reaction) at 25 mAh/g (1 C current=500 mAh/g) to 800 mAh/g and discharged (induce a delithiation reaction) at 0.05 C to 1.5 V to perform a formation process. After the formation process, the half-cells was charged (induce a lithiation reaction) at 25 mAh/g to 800 mAh/g and then, discharged (induce a delithiation reaction) to 1.0 V at 0.05 C, which were 40 times repeated. Subsequently, each of the cells was disassembled, and each cross-section SEM photograph of negative electrode plates obtained therefrom was shown in FIGS. 11 and 12. FIGS. 11 and 12 are cross-sectional photographs of the negative electrodes after charging and discharging of the half-cells including the negative electrode active material according to Example 2 and Comparative Example 2, respectively.

Referring to FIGS. 11 and 12, in the half-cell including the negative electrode active material of Example 2, no lithium precipitation occurred on the negative electrode surface, but in the half-cell including the negative electrode active material of Comparative Example 2, the negative electrode surface was non-uniform due to the lithium precipitation.

### Evaluation Example 3: Charge and Discharge Efficiency and Cycle-Life Characteristics

Each of the half-cells was charged (induce a lithiation reaction) at 25 mAh/g (1C current=500 mAh/g) to 800.3 mAh/g and discharged (induce a delithiation reaction) to 1.5 V at 0.05 C to perform a formation process. Among them, the cells of Examples 1 and 2 and Comparative Example 1 were measured with respect to charge capacity, discharge capacity, and charge and discharge efficiency, and the results are shown in Table 3.

In addition, a battery cell according to Comparative Example 4 using no active material also was evaluated with respect to charge and discharge efficiency in the same method as above (Reference: NPG Asia Materials. 9. 10.1038/am.2017.51.).

TABLE 3

| | Charge | Discharge | Charge and |
|---|---|---|---|
| | capacity | capacity | discharge |
| | (mAh/g) | (mAh/g) | efficiency (%) |
| Example 1 | 800.3 | 748.9 | 93.58 |
| Example 2 | 800.3 | 752.7 | 94.05 |
| Example 7 | 800.3 | 749.6 | 93.7 |
| Comparative Example 1 | 800.3 | 738.5 | 92.28 |
| Comparative Example 2 | 800.3 | 742.5 | 92.78 |
| Comparative Example 3 | 800.3 | 682.7 | 85.3 |

Referring to Table 3, the cells respectively including negative electrode active materials of Examples 1 and 2 exhibited excellent discharge capacity and excellent charge and discharge efficiency, compared with the cells respectively including the negative electrode active materials of Comparative Examples 1 and 2. In addition, the cell including the negative electrode active material of Example 7 exhibited excellent discharge capacity and excellent charge and discharge efficiency, compared with the cell including the negative electrode active material of Comparative Example 3.

On the other hand, the cell including the negative electrode active material of Comparative Example 4 exhibited charge and discharge efficiency of 86%, and accordingly, the cells including the negative electrode active materials of Examples 1 and 2 turned out to be improved, compared with the cell including the negative electrode active material of Comparative Example 4.

After performing a formation process, each of the half-cells was charged (induce a lithiation reaction) at 25 mAh/g to 800.3 mAh/g for 32 hours and discharged (induce a delithiation reaction) at 0.05 C to 1.0 V, which were 40 times repeated to evaluate cycle-life characteristics. Among them, the half-cells of Examples 1 and 2 and Comparative Example 1 were 10 times, 20 times, 30 times, and 40 times charged and discharged and then, evaluated with cycle-life characteristics, and the results are shown in Table 4. The half-cells of Example 7 and Comparative Examples 1 and 3 were 10 times, 20 times, and 30 times, charged and discharged and then, evaluated with cycle-life characteristics, and the results are shown in Table 5. In the charge process, the half-cells were charged at a voltage of greater than 0 V for 22 hours and at less than or equal to 0 V for 12 hours.

TABLE 4

| | 10th | 20th | 30th | 40th |
|---|---|---|---|---|
| | (mAh/g) | (mAh/g) | (mAh/g) | (mAh/g) |
| Example 1 | 782.9 | 784.1 | 785.5 | 785.8 |
| Example 2 | 786.9 | 788.7 | 789.5 | 790.7 |
| Comparative Example 1 | 777.1 | 779.5 | 780.6 | 777.6 |

Referring to Table 4, the cells including the negative electrode active materials of Examples 1 and 2 exhibited improved cycle-life characteristics, compared with the cell including the negative electrode active material of Comparative Example 1.

TABLE 5

| | 10th (mAh/g) | 20th (mAh/g) | 30th (mAh/g) |
|---|---|---|---|
| Example 7 | 784.7 | 790.1 | 789.1 |
| Comparative Example 1 | 777.1 | 779.5 | 780.6 |
| Comparative Example 3 | 763.5 | 782.6 | 785.8 |

Referring to Table 5, the cell including the negative electrode active material of Example 7 exhibited excellent cycle-life characteristics, compared with the cell including the negative electrode active material of Comparative Example 1 or 3.

The above descriptions have been made with reference to preferred embodiments of the present invention, but it will be apparent to those skilled in the art that various modifications and variations may be made in the present invention without departing from the spirit and scope of the invention as defined in the appended claims.

<Description of symbols>

| | |
|---|---|
| 1: | negative electrode active material |
| 3: | crystalline carbon |
| 3′: | lithiated crystalline carbon |
| 5: | pore |
| 7: | lithiophilic material |
| 7′: | lithiated lithiophilic material |
| 9: | lithium metal |
| 100: | rechargeable lithium battery |
| 114: | positive electrode |
| 112: | negative electrode |
| 113: | separator |
| 120: | sealing member |

What is claimed is:

1. A negative electrode active material for a rechargeable lithium battery, comprising
crystalline carbon having a plurality of pores therein, and
a lithiophilic material inside the plurality of pores,
wherein the lithiophilic material is not present on the outer surface of the crystalline carbon.

2. The negative electrode active material of claim 1, wherein
the lithiophilic material is included in an amount of 1 to 70 wt % based on a total amount of the negative electrode active material.

3. The negative electrode active material of claim 1, wherein
the lithiophilic material includes Pt, Al, Mg, Zn, Ag, Au, Si, Sn, Co, an alloy thereof, or a combination thereof.

4. The negative electrode active material of claim 1, wherein
the lithiophilic material is a catalyst that induces lithium ions to be reduced and precipitated into lithium metal within the pores when charging the rechargeable lithium battery.

5. A rechargeable lithium battery, comprising
a positive electrode and a negative electrode facing each other,
wherein the negative electrode includes the negative electrode active material according to claim 1.

6. The rechargeable lithium battery of claim 5, wherein
the negative electrode active material includes lithium metal precipitated inside the pores of the negative electrode active material.

7. The rechargeable lithium battery of claim 5, wherein
a capacity ratio of the negative electrode to the positive electrode is less than about 1.

8. The rechargeable lithium battery of claim 5, wherein
the rechargeable lithium battery is a composite rechargeable lithium battery of a lithium ion battery and a lithium metal battery.

9. A rechargeable lithium battery system, comprising a rechargeable lithium battery according to claim 5,
a driving voltage unit configured to apply a potential of the negative electrode at 0 V or less.

10. A method of preparing a negative electrode active material for a rechargeable lithium battery, comprising
depositing a precursor of a lithiophilic material on crystalline carbon having a plurality of pores thereinto coat the internal pores and outer surfaces of the crystalline carbon with the lithiophilic material; and
etching the outer surface of the crystalline carbon coated with the lithiophilic material to remove the lithiophilic material on the outer surfaces of the crystalline carbon.

11. The method of claim 10, wherein
the precursor of the lithiophilic material is hydride containing a lithiophilic material, halide containing a lithiophilic material, oxide containing a lithiophilic material, alkyl group-containing hydride containing a lithiophilic material, aryl group-containing hydride containing a lithiophilic material, alkoxide containing a lithiophilic material, an organic salt containing a lithiophilic material, an inorganic salt containing a lithiophilic material, or a combination thereof.

12. The method of claim 10, wherein
the lithiophilic material includes Pt, Al, Mg, Zn, Ag, Au, Si, Sn, Co, an alloy thereof, or a combination thereof.

13. The method of claim 10, wherein
the lithiophilic material on the outer surfaces of the crystalline carbon is removed by wet etching or dry etching.

14. The method of claim 13, wherein, the wet etching includes:
placing crystalline carbon coated with a lithiophilic material on an upper part of a filter, and
pouring an etching solution on the crystalline carbon and passing it through.

15. The method of claim 14, wherein
the etching solution is a basic solution or an acidic solution.

16. The method of claim 10, wherein
the method further includes, after coating the internal pores and outer surfaces of the crystalline carbon with the lithiophilic material, introducing a aqueous solvent into the crystalline carbon coated with the lithiophilic material and then performing a cooling.

17. The method of claim 16, wherein
the aqueous solvent includes water, alcohol or a combination thereof.

18. The method of claim 16, wherein
the cooling process is performed using a gaseous, liquid, or solid coolant.

19. The method of claim 18, wherein
the gaseous coolant is selected from low-temperature air, nitrogen gas, oxygen gas, hydrogen gas, carbon monoxide, carbon dioxide, helium, argon, ammonia, methane, ethane, or a combination thereof.

20. The method of claim 18, wherein
the liquid coolant is selected from liquid air, liquid nitrogen, liquid oxygen, liquid hydrogen, liquid carbon monoxide, liquid helium, liquid argon, liquid ammonia, liquid methane, liquid ethane, or a combination thereof.

21. The method of claim 18, wherein
the solid coolant is selected from low-temperature metals, ceramics, dry ice, or a combination thereof.

22. A rechargeable lithium battery, comprising
a positive electrode and a negative electrode facing each other,
wherein the negative electrode includes the negative electrode active material prepared according to claim 10.

23. The rechargeable lithium battery of claim 22, wherein
the negative electrode active material includes lithium metal precipitated inside the pores of the negative electrode active material.
